(19) United States
(12) Patent Application Publication
(10) Pub. No.: US 2011/0319240 A1
(43) Pub. Date: Dec. 29, 2011

(54) ROLL MEMBER, CHARGING DEVICE, PROCESS CARTRIDGE, AND IMAGE FORMING APPARATUS

(75) Inventor: Shogo TOMARI, Kanagawa (JP)

(73) Assignee: FUJI XEROX CO., LTD., Tokyo (JP)

(21) Appl. No.: 13/023,974

(22) Filed: Feb. 9, 2011

(30) Foreign Application Priority Data
Jun. 24, 2010 (JP) 2010-144172

(51) Int. Cl. B05C 1/08; C08L 71/03; C08K 3/26; C08K 3/04; B32B 27/38; G03G 15/02; G03G 21/16; C08K 3/36

(52) U.S. Cl. 492/18; 399/111; 525/403; 524/425; 524/500; 428/413; 399/176

(57) ABSTRACT

A roll member includes: a core; and an elastic layer that is formed on the core and constituted with a vulcanized substance of a rubber composition containing a polysulfide polymer (A) and an elastic material (B); wherein the polysulfide polymer (A) includes at least one structural unit selected from —(C₂H₄OCH₂OC₂H₄—Sₓ)— and —(CH₂CH(OH)CH₂—Sₓ)—, wherein x represents an integer of from 1 to 5, and includes at least one thiol group selected from —C₂H₄OCH₂OC₂H₄—SH and —CH₂CH(OH)CH₂—SH at an end thereof, and wherein the elastic material (B) is an elastic material other than the polysulfide polymer and includes at least a double bond in the chemical structure thereof.

### CROSS-REFERENCE TO RELATED APPLICATIONS

This application is based on and claims priority under 35 USC 119 from Japanese Patent Application No. 2010-144172 filed Jun. 24, 2010.

### BACKGROUND

### Technical Field

The present invention relates to a roll member, a charging device, a process cartridge, and an image forming apparatus.

### SUMMARY

According to an aspect of the invention, there is provided a roll member that has a core, and an elastic layer that is formed on the core and constituted with a vulcanized substance of a rubber composition containing a polysulfide polymer (A) and an elastic material (B);

wherein the polysulfide polymer (A) includes at least one structural unit selected from —(C₂H₄OCH₂OC₂H₄—Sₓ)— and —(CH₂CH(OH)CH₂—Sₓ)—, wherein x represents an integer of from 1 to 5, and includes at least one thiol group selected from —C₂H₄OCH₂OC₂H₄—SH and —CH₂CH(OH)CH₂—SH at an end thereof, and

wherein the elastic material (B) is an elastic material other than the polysulfide polymer and includes at least a double bond in the chemical structure thereof.

### BRIEF DESCRIPTION OF THE DRAWINGS

Exemplary embodiments of the present invention will be described in detail based on the following figures, wherein:

FIG. 1 is a schematic diagram showing an exemplary embodiment of an image forming apparatus; and

FIG. 2 is a schematic diagram showing an exemplary embodiment of a process cartridge.

### DETAILED DESCRIPTION

### <Roll Member>

The roll member in the exemplary embodiment has a core, and an elastic layer that is formed on the core. The elastic layer is constituted with a vulcanized substance of a rubber composition that contains a polysulfide polymer (A) described below and an elastic material (B) described below. The roll member in the exemplary embodiment is suppressed in the concentration variation when used as a member of an image forming apparatus.

The polysulfide polymer (A) includes at least one structural unit selected from —(C₂H₄OCH₂OC₂H₄—Sₓ)— and —(CH₂CH(OH)CH₂—Sₓ)—, wherein x represents an integer of from 1 to 5, and includes at least one thiol group selected from —C₂H₄OCH₂OC₂H₄—SH and —CH₂CH(OH)CH₂—SH at an end thereof.

The elastic material (B) is an elastic material other than the polysulfide polymer and includes at least a double bond in the chemical structure thereof.

The polysulfide polymer (A) forms a vulcanized substance by bonding of a sulfur atom possessed by the polysulfide polymer to a carbon atom that constitutes the double bond in the elastic material (B).

The roll member in the exemplary embodiment is not limited to the constitution mentioned above, and for example, the roll member may further have an intermediate layer disposed between an elastic layer and a core, a surface layer formed on the elastic layer, a resistance adjustment layer disposed between the elastic layer and the surface layer, and a coating layer (protective layer) disposed in the outside of the surface layer (outermost surface). Furthermore, the roll member in the exemplary embodiment may be also in a form constituted only with the core and the elastic layer.

Hereinafter, the constitution of each layer will be explained in detail.

### (Core)

The core is a cylindrical member that functions as an electrode and a support of the roll member. Examples of a material thereof, include a metal such as iron (free-cutting steel and the like), copper, brass, stainless steel, aluminum and nickel. Furthermore, examples of the core also include a member that is plating-treated on the outer face (for example, a resin, or a ceramic member), and a member in which a conductive agent is dispersed (for example, a resin, or a ceramic member). The core may be a hollow member (tubular member), or may be a non-hollow member.

### (Elastic Layer)

The elastic layer is constituted with a vulcanized substance of a rubber composition that contains a polysulfide polymer (A) and an elastic material (B) described below.

The polysulfide polymer (A) includes at least one structural unit selected from —(C₂H₄OCH₂OC₂H₄—Sₓ)— and —(CH₂CH(OH)CH₂—S_{X})—, wherein x represents an integer of from 1 to 5, and includes at least one thiol group selected from —C₂H₄OCH₂OC₂H₄—SH and —CH₂CH(OH)CH₂—SH at the end of the polysulfide polymer.

The elastic material (B) is an elastic material other than the polysulfide polymer and includes at least a double bond in the chemical structure thereof.

—Polysulfide Polymer (A)—

The polysulfide polymer (A) in the exemplary embodiment includes at least one structural unit selected from —(C₂H₄OCH₂OC₂H₄—Sₓ)— and —(CH₂CH(OH)CH₂—Sₓ)—, wherein x represents an integer of from 1 to 5, and includes at least one thiol group selected from —C₂H₄OCH₂OC₂H₄—SH and —CH₂CH(OH)CH₂—SH at the end of the polysulfide polymer (A).

The x preferably represents an integer of from 1 to 4, more preferably an integer of from 1 to 3, further preferably 1 or 2, and further preferably 2.

Furthermore, the polysulfide polymer desirably has a polyether moiety represented by (R¹O)ₙ—, wherein R¹ represents an alkylene group having 2 to 4 carbon atoms, and n represents an integer of from 6 to 200. By inclusion of this polyether moiety, the roll member decreases in surface hardness, and is brought into contact along the surface of a member to which the roll member is tightly pushed. Accordingly, when the roll member is used as a charging member, the charging performance with respect to a member to be charged is improved.

R¹ in the polyether moiety represents an alkylene group having 2 to 4 carbon atoms, and may be straight or branched, and is desirably straight.

Herein, n in the polyether moiety represents an integer of from 6 to 200, desirably an integer of from 50 to 150, and more desirably an integer of from 80 to 120.

The number average molecular weight of the polysulfide polymer is desirably from 500 to 10,000, more desirably from 1,000 to 8,000, and further desirably from 2,500 to 5,000.

The number average molecular weight is measured by gel permeation chromatography (GPC) with use of THF solvent, and calculated with use of a molecular weight correction curve that is prepared with a mono-dispersed polystyrene standard sample.

The polysulfide polymer in the exemplary embodiment may be those available commercially, and examples of the polysulfide polymer include THIOKOL LP-2, LP-23, LP-3 and LP-282 (manufactured by Toray Fine Chemicals Co., Ltd.).

The blending ratio of the polysulfide polymer is desirably from 5 parts by weight to 40 parts by weight, more desirably from 10 parts by weight to 30 parts by weight relative to 100 parts by weight of the elastic material described below. When the blending ratio of the polysulfide polymer is within the aforementioned range, the roll member is excellent in view of effective suppression of the concentration variation when the roll member is used as a member of an image forming apparatus.

—Elastic Material (B)—

The elastic material in the exemplary embodiment refers to the elastic material other than the polysulfide polymer and includes at least a double bond in the chemical structure thereof.

Examples of the elastic material include isoprene rubber, chloroprene rubber, epichlorohydrin rubber, butyl rubber, polyurethane, silicone rubber, fluorine rubber, styrene-butadiene rubber, butadiene rubber, nitrile rubber, ethylenepropylene rubber, epichlorohydrin-ethylene oxide copolymer rubber, epichlorohydrin-ethylene oxide-allyl glycidyl ether copolymer rubber, ethylene-propylene-diene three-component copolymer rubber (EPDM), acrylonitrile-butadiene copolymer rubber (NBR), and natural rubbers, and a mixed rubber thereof.

Among them, polyurethane, EPDM, epichlorohydrin-ethylene oxide copolymer rubber, epichlorohydrin-ethylene oxide-allyl glycidyl ether copolymer rubber, NBR, or a mixed rubber thereof is desirably used.

These elastic materials may be those foamed or may be those unfoamed.

—Vulcanized Substance—

A vulcanized substance is obtained by preparing a rubber composition that contains at least the polysulfide polymer (A) and the elastic material (B), and further an additive described below added as necessary, and heating the rubber composition.

The heating temperature and the heating time are desirably regulated depending on the kind of the polysulfide polymer or the elastic material, and heating is generally conducted at from 120° C. to 190° C. for from 2 minutes to 90 minutes.

—Other Additives—

The rubber composition may contain an additive described below for example as necessary in addition to the polysulfide polymer and the elastic material. Particularly, when the roll member is used as a member for forming the electric field such as a charging device or a transferrer in an electrophotographic system image forming apparatus, a conductive agent is added to the elastic layer.

Examples of this conductive agent include known conductive substances, or organic ion-conductive substances. In the exemplary embodiment, “conductivity” and “being conductive” indicate that the volume resistivity is from 10² Ωcm to 10¹⁴ Ωcm.

Examples of the conductive substance include quaternary ammonium salts (for example, lauryl trimethyl ammonium, stearyl trimethyl ammonium, octadodecyl trimethyl ammonium, dodecyl trimethyl ammonium, hexadecyl trimethyl ammonium, perchloric acid salt, chlorine acid salt, fluoroboric acid salt, sulfuric acid salt, ethosulfate salt, benzyl halide salt (benzyl bromide salt, benzyl chloride salt and the like) and the like of modified fatty acid dimethyl ethyl ammonium, etc.), aliphatic sulfonic acid salt, higher alcohol sulfuric acid ester salt, higher alcohol ethylene oxide adduct sulfuric acid ester salt, higher alcohol phosphoric acid ester salt, higher alcohol ethylene oxide adduct phosphoric acid ester salt, various betaines, higher alcohol ethylene oxide, polyethylene glycol fatty acid ester, and polyhydric alcohol fatty acid ester.

Example of the organic ion-conductive substance also include polyhydric alcohol (1,4-butanediol, ethylene glycol, polyethylene glycol, propylene glycol, polyethylene glycol and the like) and a complex of a derivative thereof with a metal salt, and a complex of mono-ol (ethylene glycol monomethyl ether, ethylene glycol monoethyl ether and the like) with a metal salt. Examples of the metal salt include, for example, metal salt of group I metal in the periodic system such as LiClO₄, LiCF₃SO₃, LiAsF₆, LiBF₄, NaClO₄, NaSCN, KSCN and NaCl; electrolytes such as NH₄⁺; metal salt of group II metal in the periodic system such as Ca(ClO₄)₂ and Ba(ClO₄)₂; and in addition to these, those having a group that has at least one or more active hydrogens that are reactive with isocyanate such as a hydroxy group, a carboxyl group, primary or secondary amine groups and the like. Specific examples of such complex include a complex of PEL(LiClO₄) and polyethylene glycol and the like. These conductive agents may be used alone, or may be used in combination of two or more kinds.

The addition amount of the conductive agent is not particularly limited. When the conductive agent is the conductive substance, the addition amount is, for example, in a range of from 1 part by weight to 80 parts by weight, or preferably in a range of from 15 parts by weight to 25 parts by weight relative to 100 parts by weight of the elastic material. On the other hand, when the conductive agent is the organic ion-conductive substance, the addition amount is desirably in a range of from 0.5 parts by weight to 15 parts by weight, and more desirably in a range of from 0.5 parts by weight to 3.0 parts by weight relative to 100 parts by weight of the elastic material.

Examples of the additive include materials that are normally added to an elastic layer such as a vulcanizing agent, a vulcanizing accelerator, an antioxidant, a surfactant, a coupling agent, a filler (silica, calcium carbonate and the like) and an acid acceptor.

Since the polysulfide polymer is used in the exemplary embodiment and thus the workability and the formability are excellent, the elastic layer may be formed without addition of a softener or a plasticizer. Such softener and plasticizer are desirably not added in view of bleeding suppression.

Examples of the vulcanizing agent include a vulcanizing agent that draws a halogen group out and vulcanizes such as sulfur, 2,4,6-trimercapto-s-triazine, or 6-methyl quinoxalin-2,3-dithiocarbamate. The vulcanizing agent may be used alone, or may be used in combination of two or more kinds.

The addition amount of the vulcanizing agent relative to the elastic material is not particularly limited, desirably from 0.1 parts by weight to 10 parts by weight, and more desirably from 0.3 parts by weight to 5 parts by weight relative to 100 parts by weight of the elastic material.

Examples of the vulcanizing accelerator include thiazoles, sulfenamides, thiurams, dicarbamic acid salts, and xanthogenic acid salt. The vulcanizing accelerator may be used alone, or may be used in combination of two or more kinds. In addition, known rubber blending materials such as zinc oxide and stearic acid may be added thereto. They may be used alone, or may be used in combination of two or more kinds.

The addition amount of the vulcanizing accelerator relative to the elastic material is not particularly limited, desirably from 0.1 parts by weight to 10 parts by weight, and more desirably from 0.3 parts by weight to 5 parts by weight relative to 100 parts by weight of the elastic material.

The acid acceptor may be a metal compound and/or hydrotalcites. In the exemplary embodiment, examples of the metal compound, which is used as the acid acceptor in the rubber composition for a conductive roller, include oxide, hydroxide, carbonic acid salt, carboxylic acid salt, silicic acid salt, boric acid salt and phosphorous acid salt of group II elements in the periodic system (alkali earth metal); and oxide, basic carbonic acid salt, basic carboxylic acid salt, basic phosphorous acid salt and tribasic sulfuric acid salt of group IV elements in the periodic system. Specific examples of the metal compound include magnesium oxide, magnesium hydroxide, barium hydroxide, magnesium carbonate, barium carbonate, calcium oxide, calcium hydroxide, calcium carbonate, calcium silicate, calcium stearate, zinc stearate, calcium phthalate, calcium phosphorate, zinc oxide, tin oxide, tin stearate, and basic tin phosphorite.

The addition amount of the acid acceptor relative to the elastic material is not particularly limited, desirably from 0.5 parts by weight to 20.0 parts by weight, and more desirably from 3.0 parts by weight to 10.0 parts by weight relative to 100 parts by weight of the elastic material.

Specific examples of the filler include calcium carbonate, carbon black, and silica. These inorganic fillers may be used alone, or may be used in combination of two or more kinds.

The addition amount of the filler relative to the elastic material is not particularly limited, desirably from 1 parts by weight to 80 parts by weight, and more desirably from 10 parts by weight to 50 parts by weight relative to 100 parts by weight of the elastic material.

—Preparation Method for Elastic Layer—

The rubber composition, which contains the polysulfide polymer and the elastic material, and further contains the additive as necessary, is kneaded by a kneading machine such as a kneader. The kneaded rubber composition is given to the outer circumference face of the core by extrusion molding and the like. A method of giving the kneaded rubber composition is not limited to the extrusion molding, and known various methods may be used. Then, the rubber composition is heated in this state and vulcanized to form the elastic layer. At the time of the heating, a heatable cylindrical die may be used.

—Properties of Elastic Layer—

The thickness of the elastic layer varies depending on a device to which the roll member is applied, desirably, for example, from 1 mm to 10 mm, and more desirably from 2 mm to 5 mm.

The volume resistivity of this elastic layer varies depending on a device to which the roll member is applied. When the roll member is used in a charging device of an electrophotographic system image forming apparatus described below, the volume resistivity is desirably, for example, from 10⁴ Ωcm to 10¹⁰ Ωcm, and more desirably from 10⁵ Ωcm to 10⁹ Ωcm.

Measurement of the volume resistivity is calculated with use of the following Formula (2) for a sheet-form measurement sample from a current value after 30 second application of a voltage of which the electric field (applied voltage/thickness of the composition sheet) is regulated to 1000 V/cm, with use of a measurement jig (R12702A/B resistivity chamber: manufactured by ADVANTEST CORPORATION) and a high resistance measurement machine (R8340A digital high resistance/minute current meter: manufactured by ADVANTEST CORPORATION).

Volume resistivity (Ω·cm)=[19.63×applied voltage (V)]/[current value (A)×thickness of measurement sample sheet (cm)] Formula (2)

The hardness of the elastic layer varies depending on a device to which the roll member is applied. When the roll member is used in a charging device of an electrophotographic system image forming apparatus described below, the hardness may be, for example, from 15° to 90°, or from 15° to 70° in ASKER C hardness.

Measurement of ASKER C hardness is carried out with pinning a measurement pin of ASKER C type hardness meter (manufactured by Kobunshi Keiki Co., Ltd.) on the surface of the measurement sheet having 3 mm thickness under a condition of 1,000 g loading.

(Surface Layer)

The roll member in the exemplary embodiment may form a surface layer on the elastic layer.

The surface layer is constituted by containing a resin, and as necessary, a conductive agent, particles for giving irregularity (specific surface roughness) to the surface of the surface layer, and other additives.

Examples of the resin include an acrylic resin, a cellulose resin, a polyamide resin, a copolymerized nylon, a polyurethane resin, a polycarbonate resin, a polyester resin, a polyethylene resin, a polyvinyl resin, a polyarylate resin, a styrene butadiene resin, a melamine resin, an epoxy resin, an urethane resin, a silicone resin, a fluorine resin (for example, a tetrafluoroethylene perfluoroalkylvinyl ether copolymer, a tetrafluoroethylene-hexafluoropropylene copolymer, and polyfluorovinylidene), and an urea resin. Herein, the copolymerized nylon contains any one kind or plural kinds of 610 nylon, 11 nylon and 12 nylon as a polymerization unit, and examples of other polymerization units contained in this copolymer include 6 nylon, and 66 nylon. Furthermore, as the resin, the elastic material that is blended in the elastic layer may be used.

Examples of the conductive agent that is blended in the surface layer include electron-conductive agents or ion-conductive agents. Examples of the electron-conductive agent include powders, for example, carbon blacks such as ketjen black and acetylene black; pyrolytic carbon, graphite; various conductive metals or alloys such as aluminum, copper, nickel and stainless steel; various conductive metal oxides such as tin oxide, indium oxide, titanium oxide, a solid dispersion of tin oxide-antimony oxide and a solid dispersion of tin oxide-indium oxide; and those of which the surface made of the insulating substance is treated to become conductive. Furthermore, examples of the ion-conductive agent include perchloric acid salt, chlorine acid salt and the like of tetraethyl ammonium, lauryl trimethyl ammonium and the like; and perchloric acid salt, chlorine acid salt and the like of alkali metal or alkali earth metal such as lithium and magnesium. These conductive agents may be used alone, or may be used in combination of two or more kinds.

Herein, specific examples of commercially available product of the carbon black include “SPECIAL BLACK 350”, “SPECIAL BLACK 100”, “SPECIAL BLACK 250”, “SPECIAL BLACK 5”, “SPECIAL BLACK 4”, “SPECIAL BLACK 4A”, “SPECIAL BLACK 550”, “SPECIAL BLACK 6”, “COLOR BLACK FW200”, “COLOR BLACK FW2”, “COLOR BLACK FW2V”, which are manufactured by Degussa AG; “MONARCH 1000”, “MONARCH 1300”, “MONARCH 1400”, “MOGUL-L”, “REGAL 400R”, which are manufactured by Cabot Corporation and the like.

The particles for giving irregularity (specific surface roughness) to the surface of the surface layer may be any one of conductive particles and non-conductive particles, and is desirably non-conductive particles. Examples of the conductive particles include particles of the material exemplified as the conductive agent that is blended in the elastic layer. Examples of the non-conductive particles include resin particles (polyimide resin particles, methacrylic resin particles, polystyrene resin particles, fluorine resin particles, silicone resin particles and the like), inorganic particles (clay particles, kaolin particles, talc particles, silica particles, alumina particles and the like), or ceramic particles. The particles may be particles that are constituted by the same kind of a resin as the resin, which improves compatibility of the particles with the resin, and elevates the adhesion property of the particles to the resin. Herein, the conductivity means that the volume resistivity is from 10² Ωcm to 10¹⁴ Ωcm, and the non-conductivity means that the volume resistivity is more than 10¹⁴ Ωcm. Others mean the same.

Examples of the other additives in the surface layer include materials that may be normally added to a surface layer such as a conductive agent, a curing agent, a vulcanizing agent, a vulcanizing accelerator, an antioxidant, a surfactant and a coupling agent.

The thickness of the surface layer is desirably from 7 μm to 25 μm. The volume resistivity of the surface layer is desirably from 10³ Ωcm to 10¹⁴ Ωcm.

For preparation of the surface layer, the resin and the conductive agent are dispersed in a solvent to prepare a coating liquid, and this coating liquid is applied onto the elastic layer previously prepared. Examples of the application method include Braid coating, Meyer Bar coating, spray coating, dip coating, bead coating, air knife coating, and curtain coating. The solvent used in the coating liquid is not particularly limited, and a general solvent may be used. Examples of the solvent that may be used include alcohols such as methanol, ethanol, propanol and butanol; ketones such as acetone and methyl ethyl ketone; tetrahydrofuran; and ethers such as diethyl ether and dioxane. Furthermore, in addition to these, various solvents may be used, and alcohol or ketone solvent, or a mixed solvent thereof may be used for applying dip coating, which is generally used in production of an electrophotographic photosensitive element.

(Use)

The roll member constituted as mentioned above is used as a roll member, for example, in a charging device or a transferrer and the like in an electrophotographic system image forming apparatus.

<Image Forming Apparatus and Process Cartridge>

Hereinafter, the roll member in the exemplary embodiment when it is mounted in a charging device of an image forming apparatus and a process cartridge will be explained.

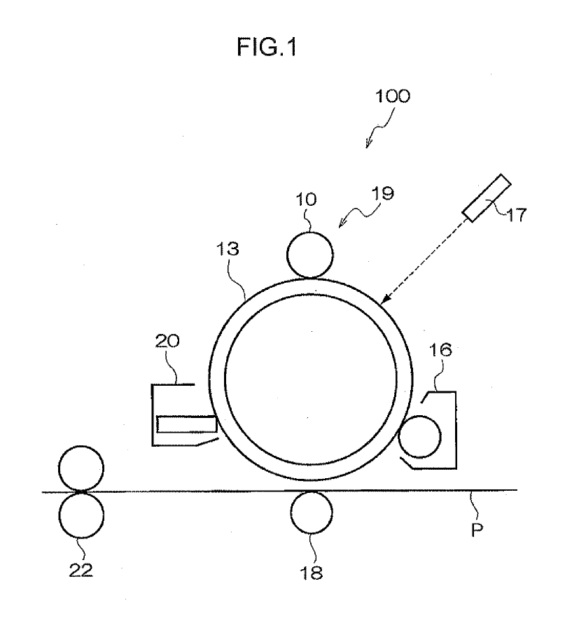

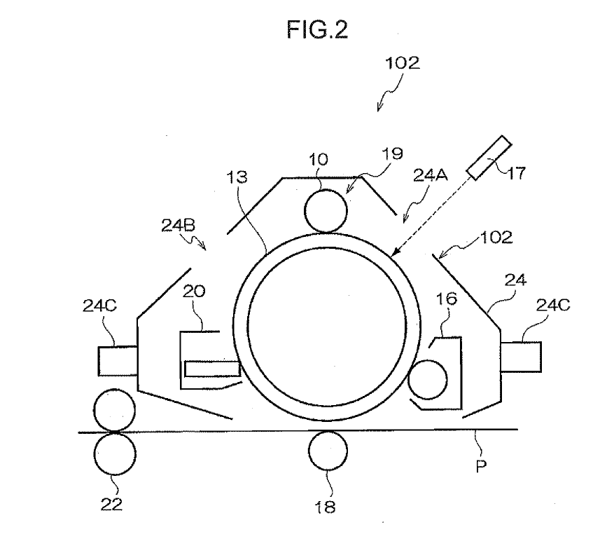

FIG. 1 is a schematic diagram showing an exemplary embodiment of the image forming apparatus. FIG. 2 is a schematic diagram showing an exemplary embodiment of the process cartridge.

As shown in FIG. 1, the image forming apparatus 100 of the exemplary embodiment has an image holder 13, and on the circumference thereof, has a charging device 19 that charges the image holder 13; a latent image forming apparatus 17 that exposes the image holder 13 charged by the charging device 19 to form a latent image; a developer 16 that develops the electrostatic latent image formed by the latent image forming apparatus 17 using a toner to form a toner image; a transferrer 18 that transfers the toner image formed by the developer 16 onto a recording medium P; and a cleaner 20 that removes residual toners on the surface of the image holder 13 after transfer. Furthermore, the image forming apparatus 100 has a fixing device 22 that fixes the toner image that has been transferred onto the recording medium P by the transferrer 18.

The image forming apparatus 100 of the exemplary embodiment is constituted in which the charging device 19 has the roll member 10 in the exemplary embodiment. This roll member 10 is disposed in contact on the surface of the image holder 13, and power-supplied from a power supply device skipped in the view, whereby to charge the image holder 13.

To the image forming apparatus 100 of the exemplary embodiment, components conventionally known as each component of an electrophotographic system image forming apparatus are applied except for the constitution of the roll member 10 installed in the charging device 19. Hereinafter, one example of each constitution will be explained.

The image holder 13 is not particularly limited, and a known photosensitive element is applied. However, an organic photosensitive element of a so-called function isolation type structure, in which a charge generation layer and a charge transport layer are isolated, is preferably used. Furthermore, as the image holder 13, preferably used are those in which the surface layer has charge transport property, and is coated with a protective layer having a cross-linkage structure. As the cross-linkage component of this protective layer, a photosensitive element containing a siloxane resin, a phenol resin, a melamine resin, a guanamine resin or an acrylic resin is also preferably used.

As the latent image forming apparatus 17, for example, a laser optical system and a LED array is used.

The developer 16 forms a toner mage, for example, by bringing a developer holder, in which a developer layer is formed on the surface, into contact with or to be adjacent to the image holder 13, and the attaching toners on the electrostatic latent image of the surface of the image holder 13. As a developing type of the developer 16, a developing type by a two component developer, which is a known type, is preferably used. Examples of the developing type by this two component developer include a cascade type, and a magnetic brush type.

As the transferrer 18, for example, a non-contact transfer type such as corotron, or a contact transfer type, in which a conductive transfer roll is brought into contact with the image holder 13 through the recording medium P to transfer the toner image onto the recording medium P, may be used.

The cleaner 20 is a member that removes toners, paper powders, dusts and the like, which are attached to the surface of the image holder 13, by, for example, bringing a plate-like member into direct contact with the surface. As the cleaner 20, in addition to the plate-like member, a brush type member, and a roll type member may be used.

Examples of the fixing device 22 include a heat fixing device. The heat fixing device has, for example, a fixing roller which has a heater lamp for heating inside a cylindrical core and a so-called release layer by a heat resistant resin film layer or a heat resistant rubber film layer on the outer the cylindrical core; and a pressure roller or a pressure belt which is disposed in contact with the fixing roller under specific contact pressure, in which a heat resistant elastic layer is formed on the outer circumference of a cylindrical core or the surface of a belt-like substrate. A fixing process with respect to unfixed toner image is conducted by inserting a recording medium P, on which unfixed toner image is transferred into the gap between, for example, the fixing roller and the pressure roller or the pressure belt, and hot-melting a binding resin, additives and the like in the toner to perform fixing.

The image forming apparatus 100 of the exemplary embodiment is not limited to the constitution mentioned above, and for example, it may be an intermediate transfer type image forming apparatus that uses an intermediate transfer body, or so-called tandem type image forming apparatus in which image forming units that form each color of the toner image are disposed in parallel.

On the other hand, as shown in FIG. 2, the process cartridge in the exemplary embodiment is a process cartridge 102 in the image forming apparatus 100 shown by FIG. 1, which is constituted by having an integral combination of an image holder 13; a charging device 19 that charges the image holder 13 and has the roll member; a developer 16 that develops an electrostatic latent image formed by a latent image forming apparatus 17 using toners to form a toner image; and a cleaner 20 that removes residual toners on the surface of the image holder 13 after the transfer, in a chassis 24 that is provided with an opening 24A for exposure, an opening 24B for neutralization and exposure, and a mounting rail 24C. The process cartridge 102 is loaded in a freely detachable way into the image forming apparatus 100 shown by FIG. 1.

The process cartridge in the exemplary embodiment is not particularly limited as long as it has the roll member in the exemplary embodiment as the charging device 19. For example, examples of the process cartridge include an embodiment in which the process cartridge has at least one selected from the image holder 13, the developer 16 and the cleaner 20 in addition to the charging device 19, and is loaded in a freely detachable way into the image forming apparatus 100, and the like. In addition, as shown in FIG. 2, the process cartridge may be an embodiment in which the developer 16 and the cleaner 20 are integrally combined.

### EXAMPLES

Hereinafter, the present invention will be further explained in detail with Examples. However, the invention is not limited to Examples described below. “Parts” herein means “parts by weight” unless otherwise stated.

### Example 1

### Preparation of Roll Member

### (Preparation of Rubber Composition)

To prepare a roll member, a mixture of the composition described below is kneaded with a tangential type pressure kneader (manufactured by MORIYAMA COMPANY LTD.: 75 L actual volume) to prepare a rubber composition.

Specifically, the temperatures of the jacket of a pressure kneader, the pressure lid and the rotor are adjusted to 20° C. with recycling water, and the elastic material described below is peptized under 0.6 MPa pressure of the pressure lid, and zinc oxide is kneaded thereto, and then stearic acid and carbon black are added and kneaded thereto, and the ion-conductive agent and calcium carbonate are added and kneaded thereto. Further, the kneaded product is cut out into a sheet form with a 22 inch open roll and cooled, and then the polysulfide polymer, the vulcanizing agent and the vulcanizing accelerator are added again and kneaded with a pressure kneader, and cut out into a sheet form with a 22 inch open roll, to give the rubber composition.

—Composition—

| | | |
|---|---|---|
| Elastic material | 100 | parts by weight |
| (epichlorohydrin-ethylene oxide - | | |
| allyl glycidyl ether copolymer | | |
| rubber, trade name: | | |
| GECHRON 3106, manufactured by | | |
| ZEON CORPORATION) | | |
| Polysulfide polymer (trade name: | 15 | parts by weight |
| THIOKOL LP-282, manufactured by | | |
| Toray Fine Chemicals Co., Ltd., | | |
| the number average molecular | | |
| weight: 3500) | | |
| Zinc oxide (trade name: ZINC | 5 | parts by weight |
| OXIDE TYPE 2, manufactured by | | |
| Seido Chemical Industry Co., Ltd.) | | |
| Stearic acid (trade name: | 1 | part by weight |
| STEARIC ACID S, manufactured | | |
| by Kao Corporation) | | |
| Carbon black (trade name: | 15 | parts by weight |
| KETJEN BLACK EC, manufactured | | |
| by Lion-sha Corporation) | | |
| Calcium carbonate (trade name: | 20 | parts by weight |
| WHITE CALCIUM CARBONATE | | |
| CCR, manufactured by | | |
| SHIRAISHI KOGYO Kaisha, Ltd.) | | |
| Ion-conductive agent | 1 | part by weight |
| (Alkyltrimethyl ammonium | | |
| perchlorate, trade name: | | |
| LXN-30, manufactured by | | |
| DAISO CO., LTD.) | | |
| Vulcanizing agent (trade name: | 1 | part by weight |
| SULFUR 200 MESH, manufactured by | | |
| TSURUMI CHEMICAL | | |
| INDUSTRY CO., LTD.) | | |
| Vulcanizing accelerator (trade | 2 | parts by weight |
| name: NOCCELER DM, manufactured | | |
| by OUCHI SHINKO CHEMICAL | | |
| INDUSTRIAL CO, LTD.) | | |
| Vulcanizing accelerator (trade | 0.5 | parts by weight |
| name: NOCCELER TT, manufactured by | | |
| OUCHI SHINKO CHEMICAL | | |
| INDUSTRIAL CO., LTD.) | | |

(Formation of Elastic Layer)

As a core, a cylindrical core made of SUS 303 having 8 mm diameter and 330 mm length is prepared. Onto this cylindrical core, the rubber composition is injected so as to be 3 mm thickness with use of a cylindrical die to form an unvulcanized rubber composition layer. Then, the temperature of the cylindrical die is elevated to 170° C., and heated for 30 minutes to vulcanize the unvulcanized rubber composition layer, whereby to form the elastic layer.

(Formation of Surface Layer)

The mixture of the composition described below is dispersed with a bead mill to prepare a dispersion. The obtained dispersion is diluted with methanol to give a surface layer coating liquid. The coating liquid is adjusted to have 45 mPa·s viscosity with methanol and butanol, and then injected into a dip coating bath.

Then, the elastic layer-attached core prepared as mentioned above is dipped in the coating liquid of the dip coating bath, and the core is pulled out. The core is dried at 150° C. for 10 minutes to remove the solvent, whereby to form the surface layer. By this, a roll member is obtained, which had the elastic layer and the surface layer in this order on the core.

—Composition of Dispersion—

| | |
|---|---|
| Polymer material (amide resin, | 100 parts by weight |
| trade name: AMILAN CM8000, | |
| manufactured by TORAY | |
| INDUSTRIES, INC) | |
| Conductive agent (carbon black, | 14 parts by weight |
| trade name: MONARCH 1000, | |
| manufactured by Cabot Corporation) | |
| Solvent (methanol, | 500 parts by weight |
| manufactured by KANTO KAGAKU) | |
| Solvent (butanol, | 240 parts by weight |
| manufactured by KANTO KAGAKU) | |

(Preparation of Sample for Measurement of Electrical Resistance and Evaluation of Bleeding Property)

Separately, a sheet-form elastic layer is prepared as a sample for measuring the electrical resistance of the elastic layer. Specifically, a rubber composition obtained by kneading of the composition is injected into a die of 2 mm×150 mm×230 mm, and this die is heated at 170° C. for 30 minutes to vulcanize the rubber composition, whereby to prepare a sheet-form elastic layer.

### Example 2

A conductive elastic layer is formed in a similar manner to that of Example 1 except for the change that the polysulfide polymer (trade name: THIOKOL LP-282, manufactured by Toray Fine Chemicals Co., Ltd., the number average molecular weight: 3500) is blended in 5 parts by weight in the rubber composition of Example 1, to give a roll member.

### Example 3

A conductive elastic layer is formed in a similar manner to that of Example 1 except for the change that the polysulfide polymer (trade name: THIOKOL LP-282, manufactured by Toray Fine Chemicals Co., Ltd., the number average molecular weight: 3500) is blended in 40 parts by weight, and the ion-conductive agent (trade name: LXN-30, manufactured by DAISO CO., LTD.) is blended in 1.5 parts by weight in the rubber composition of Example 1, to give a roll member.

### Example 4

A conductive elastic layer is formed in a similar manner to that of Example 1 except that the polysulfide polymer (trade name: THIOKOL LP-282, manufactured by Toray Fine Chemicals Co., Ltd. the number average molecular weight: 3500) is changed to a polysulfide polymer (trade name: THIOKOL LP-2, manufactured by Toray Fine Chemicals Co., Ltd., the number average molecular weight: 4000) in the rubber composition of Example 1, to give a roll member.

### Example 5

A conductive elastic layer is formed in a similar manner to that of Example 4 except for the change that the polysulfide polymer (trade name: THIOKOL LP-2, manufactured by Toray Fine Chemicals Co., Ltd., the number average molecular weight: 4000) is blended in 5 parts by weight in the rubber composition of Example 4, to give a roll member.

### Example 6

A conductive elastic layer is formed in a similar manner to that of Example 4 except for the change that the polysulfide polymer (trade name: THIOKOL LP-2, manufactured by Toray Fine Chemicals Co., Ltd., the number average molecular weight: 4000) is blended in 40 parts by weight, and the ion-conductive agent (trade name: LXN-30, manufactured by DAISO CO., LTD.) is blended in 1.5 parts by weight in the rubber composition of Example 4, to give a roll member.

### Example 7

A conductive elastic layer is formed in a similar manner to that of Example 1 except that the vulcanizing agent (trade name: SULFUR 200 MESH, manufactured by TSURUMI CHEMICAL INDUSTRY CO., LTD.) is changed to a vulcanizing agent (2,4,6-trimercapto-s-triazine, trade name: ZISNET F, manufactured by SANKYO KASEI Co., Ltd.), and that the vulcanizing accelerator (trade name: NOCCELER DM, NOCCELER TT, manufactured by OUCHI SHINKO CHEMICAL INDUSTRIAL CO., LTD.) is excluded, and that an acid acceptor (hydrotalcite, trade name: DHT-4A, manufactured by Kyowa Chemical Industry Co., Ltd.) is added in 2 parts by weight in the rubber composition of Example 1, to give a roll member.

### Example 8

A conductive elastic layer is formed in a similar manner to that of Example 1 except that the vulcanizing agent (trade name: SULFUR 200 MESH, manufactured by TSURUMI CHEMICAL INDUSTRY CO., LTD.) is changed to a vulcanizing agent (6-methyl quinoxalin-2,3-dithiocarbamate, trade name: DAISONET XL-21S, manufactured by DAISO CO., LTD.) in 1.5 parts by weight, that the vulcanizing accelerator (trade name: NOCCELER DM, NOCCELER TT, manufactured by OUCHI SHINKO CHEMICAL INDUSTRIAL CO., LTD.) is changed to a vulcanizing accelerator (DBU salt, trade name: P152, manufactured by DAISO CO., LTD.) in 1 part by weight, and that an acid acceptor (hydrotalcite, trade name: DHT-4A, manufactured by Kyowa Chemical Industry Co., Ltd.) is added in 2 parts by weight in the rubber composition of Example 1, to give a roll member.

### Example 9

A conductive elastic layer is formed in a similar manner to that of Example 1 except that the elastic material is changed to NBR (acrylonitrile butadiene rubber, trade name: DN3355, manufactured by ZEON CORPORATION) in the rubber composition of Example 1, to give a roll member.

### Example 10

A conductive elastic layer is formed in a similar manner to that of Example 1 except that the elastic material is changed to EPDM (ethylenepropylene terpolymer, trade name: EPT4021, manufactured by Mitsui Chemicals, Inc.), and that the ion-conductive agent (trade name: LXN-30 manufactured by DAISO CO., LTD.) is added in 2.0 parts by weight in the rubber composition of Example 1, to give a roll member.

### Comparative Example 1

A conductive elastic layer is formed in a similar manner to that of Example 1 except that the polysulfide polymer is replaced with a plasticizer (adipic acid ether ester-based plasticizer, trade name: RS107, manufactured by ADEKA CORPORATION) in the rubber composition of Example 1, to give a roll member.

### Comparative Example 2

A conductive elastic layer is formed in a similar manner to that of Example 1 except that the polysulfide polymer is replaced with a softener (paraffin-based process oil, trade name: DIANA PROCESS OIL PW-90, manufactured by Idemitsu Kosan Co., Ltd.) in the rubber composition of Example 1, to give a roll member.

### Comparative Example 3

A conductive elastic layer is formed in a similar manner to that of Example 1 except that the polysulfide polymer (trade name: LP-282, manufactured by Toray Fine Chemicals Co., Ltd.) is not blended in the rubber composition of Example 1, to give a roll member.

### <Evaluation>

### [Evaluation of Image Density Variation]

The roll members prepared in the Examples and Comparative Examples are brought into contact with a photosensitive element for a color copying machine, DocuCentre Color 400CP: manufactured by Fuji Xerox Co., Ltd., and in this state, are kept for 14 days under the environment of 28° C. and 85% RH.

Then, the photosensitive element and the roll member are loaded together as a charging device into a color copying machine, DocuCentre Color 400CP: manufactured by Fuji Xerox Co., Ltd. A printing test for 50,000 pieces of A4 paper (printing of 25,000 pieces under the environment of 10° C. and 15% RH, and then printing of 25,000 pieces under the environment of 28° C. and 85% RH) is carried out with use of color toners (Cyan toner, Magenta toner, Yellow toner and Black toner) for a color copying machine, DocuCentre Color 400CP. When a significant problem occurred during the test, the test is terminated.

Evaluation for the image quality is judged visually on the basis of the presence or absence of density variation in the half tone image for the images at the initial stage (3rd piece) and after 50,000 piece running as described below.

A: No defect such as density variation.

B: Very minor density variation occurred.

C: Minor density variation occurred.

D: Density variation not allowable to actual use occurred.

[Surface Hardness]

The surface hardness of the roll members prepared in the Examples and Comparative Examples is evaluated. According to JISK-6253 (year 2006 version), the pressure pin of ASKER C type hardness meter (manufactured by Kobunshi Keiki Co., Ltd.) is brought into contact with the surface of the subject to be measured, and the surface hardness is measured for 10 points under the condition of 1,000 g loading, and the average value is calculated to give evaluation of the surface hardness. The results are shown in Table 1.

—Evaluation Criteria—

A: ASKER C rubber hardness is 40 degree or more and less than 50 degree

B: ASKER C rubber hardness is 50 degree or more and less than 60 degree

C.: ASKER C rubber hardness is 60 degree or more and less than 70 degree

D: ASKER C rubber hardness is 70 degree or more

[Measurement of Electrical Resistance]

For the samples of the sheet-form elastic layer prepared for the measurement of the electrical resistance in the Examples and Comparative Examples, the volume resistivity is measured.

A measurement jig (trade name: R12702A/B resistivity chamber, manufactured by ADVANTEST CORPORATION), and a high resistance measuring machine (trade name: R8340A digital high resistance/minute current meter, manufactured by ADVANTEST CORPORATION) are used for the sheet-form measurement sample in this measurement of the volume resistivity. A voltage regulated to have 1000 V/cm of the electric field (applied voltage/thickness of the composition sheet) under the environment of 10° C. and 15% RH, is applied for 30 seconds, and the current value at this time is measured. This current value and the measured thickness of the sheet sample are applied to the following Formula (2) and the volume resistivity is calculated. The results are shown in Table 1.

Volume resistivity (Ω·cm)=[19.63×applied voltage (V)]/[current value (A)×measured thickness of sample sheet (cm))] Formula (2)

[Evaluation of Formability of Elastic Layer]

Garvey Die (according to ASTM D2230) extrusion test is performed with an extrusion machine manufactured by Brabender Technologic, and the formability is evaluated in view of (1) occurrence state of swell and bubble, (2) continuity and sharpness at 30° edge, (3) surface continuity, and (4) sharpness and continuity at an angle except for 30° edge with 4 point method. The results are shown in Table 1. The conditions for the extrusion machine are as described below.

Screw: compression ratio: 1, L/D=10, D=19.1 mm,

Temperature condition: cylinder=70° C., die=90° C.,

Brabender rotation number: 60 rpm

—Evaluation Criteria—

A: 14 to 16 points

B: 11 to 13 points

C: 8 to 10 points

D: 4 to 7 points

[Evaluation of Bleeding]

The vulcanizing sheet dangled in midair in a test room under the environment of 45° C. ambient temperature and 90% humidity, and is left to stand for 7 days. Then, silica sands (No. 6) are scattered on the surface of the vulcanizing sheet in a test room under the environment of 23° C. ambient temperature and 50% humidity, and the surface is lightly brushed. Then, with the area of the silica sand attached to the surface of the vulcanizing sheet, the bleeding property of the surface is evaluated. The results are shown in Table 1.

—Evaluation Criteria—

Area rate of the attachment of the silica sand

A: 0% or more and less than 15%

B: 15% or more and less than 30%

C: 30% or more and less than 45%

D: 45% or more

TABLE 1

| | Density | | | | | |
|---|---|---|---|---|---|---|
| | Variation | | | | | |
| | of Image | | | | | |
| | | After | | | | |
| | | Printing | | | | |
| | | of | Surface | Electric | | |
| | Initial | 50,000 | Hard- | Resistance | Forma- | Bleed- |
| | Stage | pieces | ness | [Ω · cm] | bility | ing |
| Example 1 | A | A | A | 7.76 × 10⁶ | A | A |
| Example 2 | A | B | B | 3.39 × 10⁶ | B | A |
| Example 3 | A | B | A | 7.94 × 10⁶ | A | A |
| Example 4 | A | A | A | 3.31 × 10⁷ | A | A |
| Example 5 | A | B | B | 2.04 × 10⁷ | B | A |
| Example 6 | A | B | A | 5.59 × 10⁷ | A | A |
| Example 7 | A | A | B | 1.26 × 10⁸ | A | A |
| Example 8 | A | A | B | 1.35 × 10⁸ | A | A |
| Example 9 | A | A | A | 2.24 × 10⁷ | A | A |
| Example 10 | A | A | A | 1.91 × 10⁸ | B | A |
| Comparative | B | D | A | 5.25 × 10⁶ | A | D |
| Example 1 | | | | | | |
| Comparative | A | D | A | 3.89 × 10⁶ | A | D |
| Example 2 | | | | | | |
| Comparative | D | D | D | 3 .89 × 10⁶ | D | A |
| Example 3 | | | | | | |

The image evaluations for the roll members with use of the polysulfide polymer (A) and the elastic material (B) is carried out in Examples. As a result, occurrence of the density variation is suppressed as shown in Table 1.

On the other hand, in Comparative Examples 1 and 2, a plasticizer or a softener is blended and molded instead of the polysulfide polymer to give a roll member, which causes image variation. This image variation is considered to be due to contamination of the photosensitive element by occurrence of the bleeding. Furthermore, the roll member in which the polysulfide polymer is not blended in Comparative Example 3 has noticeably high rubber hardness, causes poor charging, and causes image variation.

From the results described above, it is understood that a roll member that forms an elastic layer with use of a polysulfide polymer suppresses variation of image density.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is Claimed is:

1. A roll member comprising:
a core; and
an elastic layer that is formed on the core and constituted with a vulcanized substance of a rubber composition containing a polysulfide polymer (A) and an elastic material (B);
wherein the polysulfide polymer (A) includes at least one structural unit selected from —(C₂H₄OCH₂OC₂H₄—Sₓ)— and —(CH₂CH(OH)CH₂—Sₓ)—, wherein x represents an integer of from 1 to 5, and includes at least one thiol group selected from —C₂H₄OCH₂OC₂H₄—SH and —CH₂CH(OH)CH₂—SH at an end thereof, and
wherein the elastic material (B) is an elastic material other than the polysulfide polymer and includes at least a double bond in the chemical structure thereof.

2. The roll member according to claim 1,
wherein the rubber composition contains the polysulfide polymer (A) in a content of from 5 parts by weight to 40 parts by weight relative to 100 parts by weight of the elastic material (B).

3. The roll member according to claim 1,
wherein the polysulfide polymer (A) further includes a polyether moiety represented by —(R¹O)ₙ—, wherein R¹ represents an alkylene group having 2 to 4 carbon atoms and n represents an integer of from 6 to 200.

4. The roll member according to claim 1, wherein the polysulfide polymer (A) has a number average molecular weight of from 500 to 10,000.

5. The roll member according to claim 1, wherein the elastic material (B) includes epichlorohydrin-ethylene oxide-allyl glycidyl ether copolymer rubber.

6. The roll member according to claim 1, wherein the rubber composition further comprises a vulcanizing agent which includes at least one selected from sulfur, 2,4,6-trimercapto-s-triazine or 6-methyl quinoxalin-2,3-dithiocarbamate, wherein a content of the vulcanizing agent is from 0.1 parts by weight to 10 parts by weight relative to 100 parts by weight of the elastic material (B).

7. The roll member according to claim 1, wherein the rubber composition further comprises a vulcanizing accelerator in a content of from 0.1 parts by weight to 10 parts by weight relative to 100 parts by weight of the elastic material (B).

8. The roll member according to claim 1, wherein the rubber composition further comprises an organic ion-conductive substance in a content of from 0.5 parts by weight to 15 parts by weight relative to 100 parts by weight of the elastic material (B).

9. The roll member according to claim 1, wherein the rubber composition further comprises an acid acceptor in a content of from 0.5 parts by weight to 20 parts by weight relative to 100 parts by weight of the elastic material (B).

10. The roll member according to claim 1, wherein the rubber composition further comprises a filler which includes at least one selected from calcium carbonate, carbon black or silica, wherein a content of the filler is from 1 part by weight to 80 parts by weight relative to 100 parts by weight of the elastic material (B).

11. The roll member according to claim 1, further comprising surface layer being laid over the elastic layer.

12. A charging device comprising the roll member according to claim 1.

13. A process cartridge comprising:
the charging device according to claim 12, which charges an image holder; and
at least one selected from the image holder, a developer that develops an electrostatic latent image on the image holder using toners to form a toner image, and a cleaner that removes residual toner remaining on a surface of the image holder after transferring of the toner image onto a transfer body,
wherein the process cartridge is attachable to and detachable from an image forming apparatus.

14. An image forming apparatus comprising:
an image holder;
the charging device according to claim 12, which charges the image holder;
a latent image former that forms an electrostatic latent image on the image holder charged by the charging device;
a developer that develops the electrostatic latent image on the image holder using toners to form a toner image; and
a transferrer that transfers the toner image formed on the image holder by the developer, onto a transfer body.
